(19) United States
(12) Patent Application Publication
(10) Pub. No.: US 2001/0023458 A1
(43) Pub. Date: Sep. 20, 2001

(54) Automatic construction of directories in network terminals

(76) Inventor: Laurent Gavoille, Auvers Sur Oise (FR)

Correspondence Address: Lawrence E. Laubscher, Sr., 745 South 23rd Street, Arlington, VA, 22202-2451, US

(21) Appl. No.: 09/785,457

(22) Filed: Feb. 20, 2001

(30) Foreign Application Priority Data
Feb. 24, 2000 (FR) 00-02485

(51) Int. Cl. G06F 15/16; G06F 15/173

(52) U.S. Cl. 709/245; 709/223

(57) ABSTRACT

To construct directories automatically in a group of terminals of a local area network, a given terminal that has just been connected broadcasts a message containing its name and address. Another terminal of the group decodes the broadcast message, extracts the name and address of the given terminal from the broadcast message in order to insert them in a directory, and transmits its name and its address in a response message containing the address of the given terminal. The given terminal decodes the response message, extracts the name and the address of the other terminal from the response message, and inserts them in a directory.

### BACKGROUND OF THE INVENTION

1. Field of the Invention

The present invention relates generally to digital terminals, in particular telephone terminals, interconnected via a local area network LAN. The invention relates more particularly to the automatic construction of directories of called parties in the terminals when a new terminal is connected to the network or when one of the terminals changes its address.

2. Description of the Prior Art

In a local area network supporting the Transport Control Protocol/Internet Protocol TCP/IP at the level of the network and transport layers, i.e. in intranet networks, each terminal is associated with an IP address including, for example, a series of four bytes, for example 143.14.18.178, and where appropriate a network name which is not very evocative of the terminal, for example PC63B912. As terminal users are not accustomed to using designations of this kind, which are the preserve of data processing specialists, it has proved necessary to construct a directory manually in each terminal to contain the usual names of the other terminals of the network so that they can be addressed easily, such usual names being printer X, station Y, fax 3, etc, for example. Thus in each terminal a translator function associated with its directory maps the usual name of each terminal that can be called to the IP address or the network name of the terminal.

As is well known in the art, when a given terminal is to be added to a local area network, it is necessary not only to write all the other terminals of the network into the directory of the given terminal, which is fastidious in itself, but also to update the directories of all the terminals of the network to include the given terminal, which is also fastidious. If the network contains several dozen or hundred terminals, loading the addresses and names into the terminals when a given terminal is installed represents several hours of work.

### OBJECT OF THE INVENTION

The main object of this invention aims to remedy the drawbacks referred to above by automatically constructing the directory of the new terminal connected to a network and automatically updating the directories of the other terminals of the network, which has the advantage of avoiding the need to use the services of a data processing specialist to list a new terminal in a local area network.

### SUMMARY OF THE INVENTION

Accordingly, a method of constructing directories in terminals connected by a local area network, the method includes the following steps:

broadcasting a message from a given terminal in the network, the broadcast message containing at least a name and an address of the given terminal,

in at least one other terminal, decoding the broadcast message, extracting from it the name and the address of the given terminal, inserting the extracted name and address in mapping relationship into a directory of the other terminal, and transmitting a response message containing the address of the given terminal as a receiver address and at least the name and the address of the other terminal extracted from the broadcast message, and

decoding the response message in the given terminal, extracting the name and the address of the other terminal from it, and inserting the extracted name and address in mapping relationship into a directory of the given terminal.

When the network comprises plural types of terminals, for example fax and computers, the given terminal and plural other terminals in the network define a group of terminals associated with an identifier. The broadcast message includes then preferably said identifier so that only said plural other terminals decode the broadcast message to extract from it the name and the address of the given terminal.

The broadcast message and the response message can each include a directory construction function field.

The address contained in the broadcast message or the response message can include a sender terminal address conforming to the internet protocol and/or an electronic mail address of the sender terminal.

The broadcasting step follows on automatically from the given terminal being connected to the network which can be preceded by a first installation of the given terminal in the network or by disconnecting (powering down) the given terminal.

### BRIEF DESCRIPTION OF THE DRAWINGS

Other features and advantages of the present invention will become more clearly apparent after reading the following description of preferred embodiments of the invention, which description is given with reference to the corresponding accompanying drawings, in which:

FIG. 1 is a block diagram of a local area network including a few terminals;

FIG. 2 shows the structure of a level identification packet at the IP protocol according to the invention; and

FIG. 3 is an algorithm of the steps of a method of constructing directories in the terminals of the FIG. 1 local area network.

### DESCRIPTION OF THE PREFERRED EMBODIMENTS

This example refers to a CSMA/CD (Carrier Sense Multiple Access/Collision Detect) local area network whose topology is based on a bus BU. In FIG. 1, the network comprises N terminals T₁ to T_{N} connected to the bus BU. In this kind of network a terminal can send a frame if it does not detect any frame on the bus BU. The preferred embodiment referred to hereinafter relates to an Ethernet network in which the frames encapsulate IP packets conforming to the TCP/IP protocols. FIG. 1 does not show other machines that may be connected to the bus BU, for example a gateway between the local area network and the public switched telephone network constituting a PABX type private data processing platform.

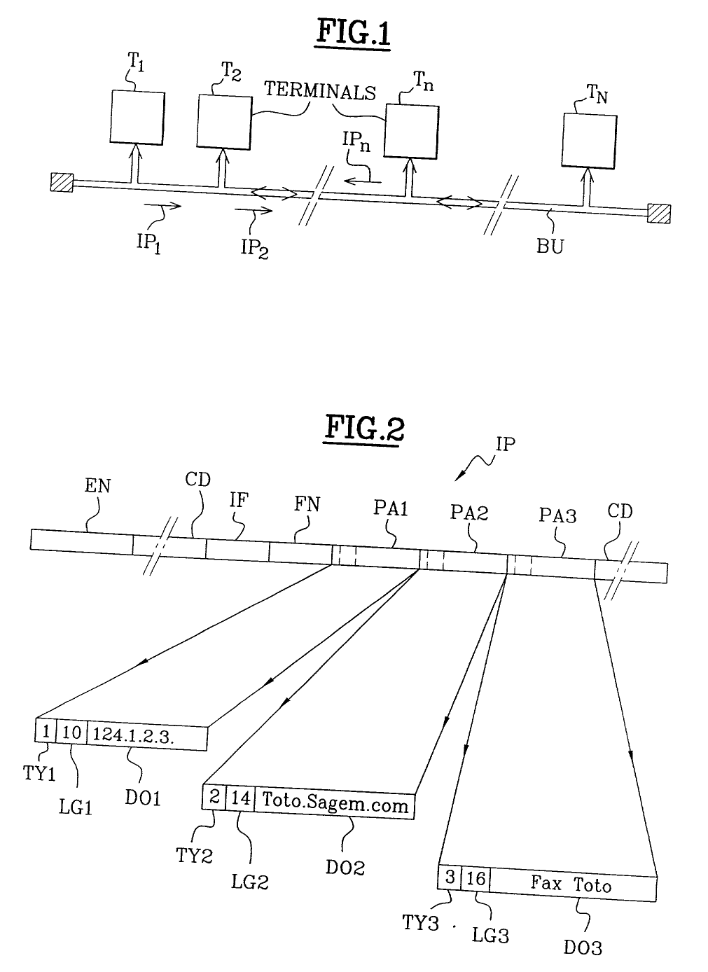

FIG. 2 shows the general structure of an IP packet with a standard header EN and a data field CD. The header includes the address of the sender of the packet if the packet is broadcast or that address and a receiver address and at least the address of the source port and the address of the destination port in relation with the directory application in a terminal at the TCP transport layer level.

According to the invention, the data field CD includes an identification field IF, a function field FN and parameter fields PA. The identification field IF contains several characters that identify a group of terminals; for example, the group of terminals T₁, T₂ and Tₙ, with 1≦n≦N, referred to hereinafter, selected from the set of all the terminals T₁ to T_{N} Of the network, contains the same “fax” identifier so that the data field CD of a packet containing an identifier of that kind is processed only by the terminals T₁, T₂ and Tₙ. The function field FN containing a few bits indicates a function to be implemented in the terminal receiving the IP packet, for example a directory update function.

Each parameter field PA is made up of three sub-fields TY, LG and DO. The fields TY and LG respectively specify the data type and the length of the data contained in the sub-field DO. For example, three parameter fields PA1, PA2 and PA3 are included in the data field CD of the IP packet. The parameter in the field PA1 relates to the IP address of the terminal sending the IP packet, for example “124.1.2.3.”, contained in the sub-field DO1, having a length of ten characters, as indicated in the sub-field LG1, and corresponding to the type TY1=1. The parameter in the field PA2 relates to the electronic mail (e-mail) address of the sending terminal contained in the sub-field DO2, for example “Toto.Sagem.com”, having a length of fourteen characters, as indicated in the sub-field LG2, and corresponding to the type TY2=2. The parameter in the field FA3 relates to the network name, or preferably the usual name, of the sending terminal contained in the sub-field DO3, for example “Fax Toto”, having a length of sixteen characters, as indicated in the sub-field LG3, and corresponding to a third type indicated in the sub-field TY3=3.

As explained hereinafter, this kind of a packet IPₙ is broadcast by the terminal Tₙ in particular when it is installed in the network and the packets IP₁ and IP₂ of this kind are respectively transmitted in response from the terminals T₁ and T₂ to the terminal Tₙ. The packet IPₙ is a broadcast packet which is addressed only to the other terminals T₁, T₂ of the same group, which are characterized by an identifier IF common to the terminals T₁, T₂ and Tₙ, while the packets IP₁ and IP₂ are intended only for the terminal Tₙ and consequently contain its address as the receiver address.

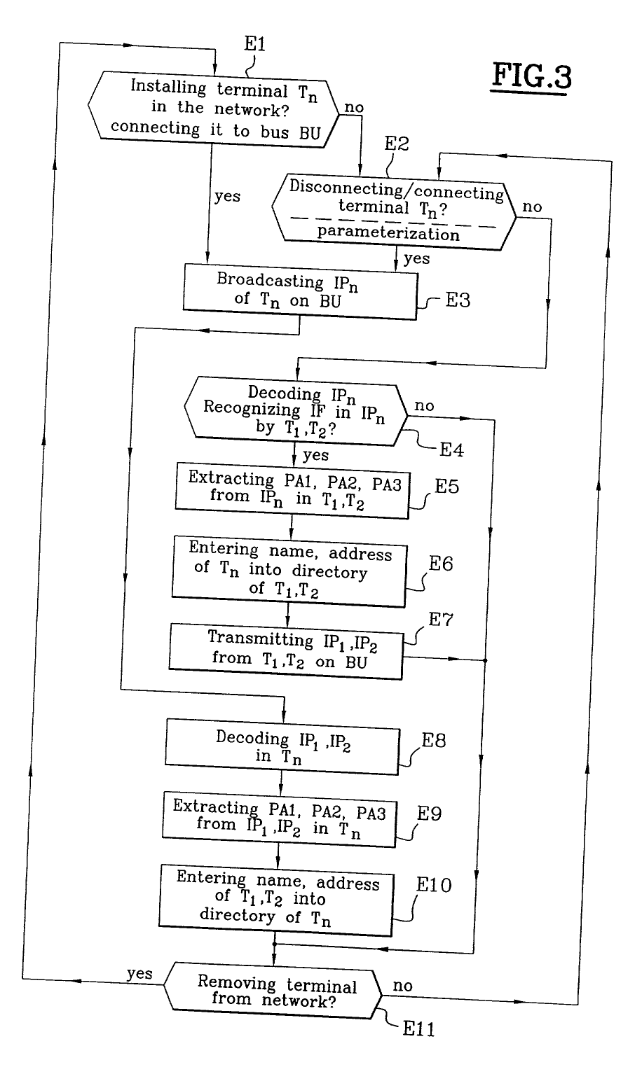

The construction of directories in the terminals T₁, T₂ and Tₙ shown in FIG. 3 is triggered by one of two events signaled in steps E1 and E2.

In step E1, the terminal Tₙ is inserted into the network by installing it and then connecting it to the bus BU. The content of the fields IF, FN and PA1 to PA3 relating to the terminal Tₙ, as the sender terminal, can be determined at least in part by the terminal manufacturer and/or at least in part by the terminal user.

For step E2, it is assumed that one of the parameters PA1 to PA3 relating to the terminal Tₙ already installed has been modified at the time of a connection to the network. For example, the network includes a server containing the DHCP (Dynamic Host Configuration Protocol) for dynamically attributing IP addresses to the terminals T₁ to T_{N} Of the network, or more generally for dynamically allocating at least one of the parameters PA1 to PA3 relating to the terminal Tₙ when the latter is connected to the network for the first time, as in step E1, or more generally when it is connected to the network each time it is powered up. The server therefore configures the terminal Tₙ automatically in step E2 by dynamically allocating it an IP address.

After step E1 or E2, the method of constructing directories includes the successive main steps E3 to E11, of which steps E3 and E8 to E11 are executed in the calling terminal Tn and steps E4 to E7 and E11 are executed in each of the called terminals T₁ and T₂.

After step E1 or E2, following connection of the terminal Tₙ to the network bus BU, the terminal Tₙ broadcasts on the bus BU the packet IPₙ containing in particular parameters PA1, PA2 and PA3 which are specific to the step E3. In particular, the packet IPₙ contains the identifier IF common to all the terminals T1, T2 and Tₙ Of the “fax” group in the network.

All the terminals in the network reject the packet IPₙ except for the terminals T₁ and T₂, which recognize the identifier IF specific to their group. Each terminal T₁ T₂ then executes steps E4 to E7.

In step E4 the packet IPₙ is decoded in the receiver of the terminal T₁, T₂, which recognizes the group identifier IF. At the level of the application service designated by the destination port in the field FN of the packet IPₙ and relating to updating of directories, in step E5 the terminal T₁, T₂ extracts the parameter fields PA1 to PA3 from the packet IPₙ. The directory in the terminals T₁, T₂ is then updated (step E6), in particular by entering as a new usual name the name of the terminal Tₙ contained in the sub-field DO3 extracted from the packet IPₙ and the parameters in the other sub-fields DO1 and DO2 extracted from the packet IPₙ enabling the terminal Tₙ to be called from the terminal T₁, T₂. If, in harmony with step E2, terminal Tₙ is already listed in the directory in the terminal T₁, T₂, the parameter(s) contained in the data field of the packet IPₙ respectively replace the parameter(s) already stored in the directory of the terminal T1, T2.

After this updating of the directory, the terminal T₁, T₂ transmit a packet IP₁, IP₂ conventionally containing their address as the sender address, the address of the terminal Tₙ as the receiver address, by means of the address IP contained in the sub-field DO1 of the packet IPₙ that has just been received, and parameters PA1 to PA3 enabling the terminal Tₙ subsequently to call the terminals T₁, T₂ (step E7).

The terminal Tₙ executes steps E8, E9 and E10, which are respectively analogous to steps E4, E5 and E6, in response to each packet IP₁, IP₂. Because this packet contains the address of the terminal Tₙ , the packet IP₁, IP₂ is recognized only by the terminal Tₙ and the directory updating application service is activated after the group identifier detected in the field IF and the corresponding function detected in the field FN of the packet IP₁, IP₂, respectively (step E8). The parameters PA1, PA2, and PA3 are extracted from the packet IP₁, IP₂ thereby constructing the directory in the terminal Tₙ , by mapping the name of the terminal T₁, T₂ in the sub-field DO3 of the packet IP₁, IP₂ to the address IP and the electronic mail address contained in the sub-fields DO1 and DO2 of the packet IP₁, IP₂ (step E10). The directory in the terminal Tₙ is therefore constructed automatically in response to all of the packets IP₁, IP₂ from the terminals T₁, T₂ in the group to which the terminal Tₙ belongs.

After step E7 in each called terminal T₁, T₂, or after step E10 in the initially calling terminal Tₙ , the method of constructing directories is iterated (step E11) if any of the terminals of the group in question, which has now become the terminal Tₙ, is disconnected from the network, i.e. is stopped, and then restarted (step E2).

Accordingly, a user taking place in front of the terminal Tₙ can send a message, for example a fax message, directly to one of the terminals T₁, T₂ of the group using the local directory in the terminal Tₙ that has just been constructed automatically, without any intervention on this directory by the user. Similarly, after the terminal Tₙ is installed or has been connected, a user taking place in front of the terminal T₁, T₂ can transmit a message, for example a fax message, directly to the terminal Tₙ using the local directory included in the terminal T₁, T₂ that has just been updated automatically, without any intervention on this directory.

The invention is not limited to an Ethernet local area network (LAN) as described above, and can be applied to any form of local area network, regardless of its size, and therefore to any local area network LAN that can be installed in a private home or in a company, or any metropolitan area network (MAN) installed in a building or in several buildings of a business, and can be applied to any local area network regardless of its architecture and its technology and therefore to any single-bus or double-bus, star-connected, cable, ring or optical fiber network, or wireless WLAN or high-performance radio LAN (HiperLAN).

What I claim is:

1. A method of constructing directories in terminals connected by a local area network, said method including the following steps:
broadcasting a message from a given terminal in the network, the broadcast message containing at least a name and an address of said given terminal,
in at least one other terminal, decoding said broadcast message, extracting from it a name and an address of said given terminal, inserting the extracted name and address in mapping relationship into a directory of said other terminal, and transmitting a response message containing the address of said given terminal as a receiver address and at least a name and an address of said other terminal extracted from said broadcast message, and
decoding said response message in said given terminal, extracting said name and said address of said other terminal from the decoded response message, and inserting the extracted name and address in mapping relationship into a directory of said given terminal.

2. The method claimed in claim 1, wherein said given terminal and plural other terminals in said network define a group of terminals associated with an identifier, and said broadcast message includes said identifier so that only said plural other terminals decode said broadcast message to extract from it said name and said address of said given terminal.

3. The method claimed in claim 1, wherein said broadcast message and said response message each include a directory construction function field.

4. The method claimed in claim 1, wherein said address contained in said broadcast message or in said response message includes a sender terminal address conforming to the internet protocol and/or an electronic mail address of said sender terminal.

5. The method claimed in claim 1, wherein said broadcasting step follows on automatically from said given terminal being connected to said network.
